(19) United States
(12) Patent Application Publication
(10) Pub. No.: US 2026/0214265 A1
(43) Pub. Date: Jul. 23, 2026

(54) A METHOD, AN APPARATUS AND A COMPUTER PROGRAM PRODUCT FOR IMAGE AND VIDEO PROCESSING

(71) Applicant: Nokia Technologies Oy, Espoo (FI)

(72) Inventors: Honglei ZHANG, Tampere (FI); Miska Matias HANNUKSELA, Tampere (FI); Alireza AMINLOU, Tampere (FI); Francesco CRICRÌ, Tampere (FI); Jukka Ilari AHONEN, Tampere (FI); Nam Hai LE, Tampere (FI); Hamed REZAZADEGAN TAVAKOLI, Espoo (FI)

(21) Appl. No.: 19/144,462

(22) PCT Filed: Oct. 6, 2023
(86) PCT No.: PCT/FI2023/050572

§ 371 Date: Jun. 28, 2025

(30) Foreign Application Priority Data
Dec. 29, 2022 (FI) 20226177

(51) Int. Cl. H04N 19/59; G06N 3/0455; G06T 7/194; H04N 19/117; H04N 19/119; H04N 19/124; H04N 19/82

(52) U.S. Cl. CPC H04N 19/59; G06N 3/0455; G06T 7/194; H04N 19/117; H04N 19/119; H04N 19/124; H04N 19/82

(57) ABSTRACT

The embodiments relate to method comprising receiving an input frame (1410); transforming the input frame to generate a latent representation to be quantized (1420); determining from the latent representation a foreground region of the input frame and a background region of the input frame having corresponding foreground elements and corresponding background elements (1430); downsampling the latent representation into low-level resolution representations (1440); estimating parameters of a probability distribution of a selected set of elements of the latent representation and estimating values for rest of the elements at each resolution level (1450); and encoding the latent representation into a bitstream using the estimated parameters of the probability distribution for the selected set of elements and using estimated values for the rest of the elements (1460). The embodiments also relate to a method for decoding, and apparatuses for implementing the methods.

### TECHNICAL FIELD

The present solution generally relates to image and video processing.

### BACKGROUND

One of the elements in image and video compression is to compress data while maintaining the quality to satisfy human perceptual ability. However, in recent development of machine learning, machines can replace humans when analyzing data for example in order to detect events and/or objects in video/image. The present embodiments can be utilized in Video Coding for Machines, but also in other use cases.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding comprising means for receiving an input frame; means for transforming the input frame to generate a latent representation to be quantized; means for determining from the latent representation a foreground region of the input frame and a background region of the input frame having corresponding foreground elements and corresponding background elements; means for downsampling the latent representation into low-level resolution representations; means for estimating parameters of a probability distribution of a selected set of elements of the latent representation and estimating values for rest of the elements at each resolution level; and means for encoding the latent representation into a bitstream using the estimated parameters of the probability distribution for the selected set of elements and using estimated values for the rest of the elements.

According to a second aspect, there is provided an apparatus for decoding comprising means for receiving an encoded bitstream; means for decoding information on elements being encoded in the received bitstream; means for decoding lowest-resolution representation of a latent representation using a probability distribution model for elements that are encoded, wherein an estimated value is used for elements that has not been encoded in the bitstream; means for continuing decoding elements in higher-resolution representations by the probability distribution using elements of lower-resolution representation that have been decoded or estimated until all elements in the highest-resolution latent representation have been decoded; and means for generating a reconstructed frame based on the highest-resolution latent representation.

According to a third aspect, there is provided a method for encoding, comprising receiving an input frame; transforming the input frame to generate a latent representation to be quantized; determining from the latent representation a foreground region of the input frame and a background region of the input frame having corresponding foreground elements and corresponding background elements; downsampling the latent representation into low-level resolution representations; estimating parameters of a probability distribution of a selected set of elements of the latent representation and estimating values for rest of the elements at each resolution level; and encoding the latent representation into a bitstream using the estimated parameters of the probability distribution for the selected set of elements and using estimated values for the rest of the elements.

According to a fourth aspect, there is provided a method for decoding, comprising receiving an encoded bitstream; decoding information on elements being encoded in the received bitstream; decoding lowest-resolution representation of a latent representation using a probability distribution model for elements that are encoded, wherein an estimated value is used for elements that has not been encoded in the bitstream; continuing decoding elements in higher-resolution representations by the probability distribution using elements of lower-resolution representation that have been decoded or estimated until all elements in the highest-resolution latent representation have been decoded; and generating a reconstructed frame based on the highest-resolution latent representation.

According to a fifth aspect, there is provided an apparatus for encoding, the apparatus comprising at least one processor, memory including computer program code, the memory and the computer program code configured to, with the at least one processor, cause the apparatus to perform at least the following: receive an input frame; transform the input frame to generate a latent representation to be quantized; determine from the latent representation a foreground region of the input frame and a background region of the input frame having corresponding foreground elements and corresponding background elements; downsample the latent representation into low-level resolution representations; estimate parameters of a probability distribution of a selected set of elements of the latent representation and estimating values for rest of the elements at each resolution level; and encode the latent representation into a bitstream using the estimated parameters of the probability distribution for the selected set of elements and using estimated values for the rest of the elements.

According to a sixth aspect, there is provided an apparatus for decoding, the apparatus comprising at least one processor, memory including computer program code, the memory and the computer program code configured to, with the at least one processor, cause the apparatus to perform at least the following: receive an encoded bitstream; decode information on elements being encoded in the received bitstream; decode lowest-resolution representation of a latent representation using a probability distribution model for elements that are encoded, wherein an estimated value is used for elements that has not been encoded in the bitstream; continue decoding elements in higher-resolution representations by the probability distribution using elements of lower-resolution representation that have been decoded or estimated until all elements in the highest-resolution latent representation have been decoded; and generate a reconstructed frame based on the highest-resolution latent representation.

According to a seventh aspect, there is provided computer program product for decoding comprising computer program code configured to, when executed on at least one processor, cause an apparatus or a system to: receive an input frame; transform the input frame to generate a latent representation to be quantized; determine from the latent representation a foreground region of the input frame and a background region of the input frame having corresponding foreground elements and corresponding background elements; downsample the latent representation into low-level resolution representations; estimate parameters of a probability distribution of a selected set of elements of the latent representation and estimating values for rest of the elements at each resolution level; and encode the latent representation into a bitstream using the estimated parameters of the probability distribution for the selected set of elements and using estimated values for the rest of the elements.

According to an eighth aspect, there is provided computer program product for decoding comprising computer program code configured to, when executed on at least one processor, cause an apparatus or a system to: receive an encoded bitstream; decode information on elements being encoded in the received bitstream; decode lowest-resolution representation of a latent representation using a probability distribution model for elements that are encoded, wherein an estimated value is used for elements that has not been encoded in the bitstream; continue decoding elements in higher-resolution representations by the probability distribution using elements of lower-resolution representation that have been decoded or estimated until all elements in the highest-resolution latent representation have been decoded; and generate a reconstructed frame based on the highest-resolution latent representation.

According to an embodiment for encoding, a method for estimating the values for the rest of the elements is determined and an indication of the method for estimating is encoded into a bitstream.

According to an embodiment for encoding, an estimation method for the latent representation is determined at each resolution level.

According to an embodiment for encoding, a method for estimating the selected set of elements is determined.

According to an embodiment for encoding, a set of parameters for the determined estimation method is determined and the set of parameters is encoded into the bitstream.

According to an embodiment for encoding, a binary mask representing foreground regions is used to identify a foreground region in the latent representation

According to an embodiment for encoding, the latent representation is partitioned into blocks, and it is determined whether elements in a block are foreground elements or background elements, and an indication mask indicating the foreground elements and the background elements is generated and encoded into a bitstream.

According to an embodiment for encoding, the values for rest of the elements are estimated by using one of the following: a nearest neighbor algorithm; a linear interpolation algorithm using elements having already been processed; a predictor neural network being trained to predict the values of for rest of the elements using the elements that have already been processed.

According to an embodiment for encoding, the selected set of elements comprises foreground elements, and the rest of the elements comprises background elements.

According to an embodiment for encoding, different scale factors are applied to different regions of the latent representation before the latent representation is processed for the probability distribution.

According to an embodiment for decoding, the information on elements that are encoded in the received bitstream comprises one or more of the following: information on location and size of foreground region; information on location and size of background region; indication information of set of elements that are encoded; indication information of set of elements that are skipped.

According to an embodiment for decoding, the highest-resolution latent representation is dequantized before reconstructing the frame.

According to an embodiment, one or more scaling factors, and/or index of the predefined scaling factors and/or difference of the scaling factors are encoded into or decoded from the bitstream.

According to an embodiment for decoding, the scaling factor is determined for an element in the latent representation based on the information on the element that is decoded from the bitstream, and an inverse of the scaling factor is applied to the element after it has been decoded from the bitstream.

According to an embodiment for decoding, a recovery filter is used for improving quality of elements that have not been encoded in the bitstream.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows another example of a video coding system with neural network components;

FIG. 3 shows an example of a neural network-based end-to-end learned codec;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned codec;

FIG. 8 shows an example of a multi-scale progressive probability model;

FIG. 9 shows an example of pixel groups of a latent representation;

FIG. 10 shows an example of channel processing order;

FIG. 11 shows an example of a prediction model in a multi-scale progressive probability model;

FIG. 12 shows an example of pattern for foreground pixels and background pixels;

FIG. 13a shows an example of skipped channel pattern for foreground pixels;

FIG. 13b shows an example of skipped channel pattern for background pixels;

FIG. 14 is a flowchart illustrating a method for encoding according to an embodiment;

FIG. 15 is a flowchart illustrating a method for decoding according to an embodiment; and

FIG. 16 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation, i.e., several portions of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state. Neural networks are being utilized in an ever-increasing number of applications for many different types of devices, such as mobile phones. Examples include image and video analysis and processing, social media data analysis, device usage data analysis, etc.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-1 Part 3) is a video compression standard developed as the successor to HEVC. A reference software for VVC is the VVC Test Model (VTM).

A specification of the AV1 bitstream format and decoding process were developed by the Alliance of Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YcgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index may be predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor A to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

A bitstream may be defined as a sequence of bits, which may in some coding formats or standards be in the form of a network abstraction layer (NAL) unit stream or a byte stream, which forms the representation of coded pictures and associated data forming one or more coded video sequences.

A bitstream format may comprise a sequence of syntax structures.

A syntax element may be defined as an element of data represented in the bitstream. A syntax structure may be defined as zero or more syntax elements present together in the bitstream in a specified order.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content will not be as a source for prediction, and thus it may only impact the visual quality of the frames that are output by the decoder.

Recently, neural networks (NNs) have been used in the context of image and video compression by following mainly two approaches.

In one approach, NNs are used to replace one or more of the components of a traditional codec such as VVC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

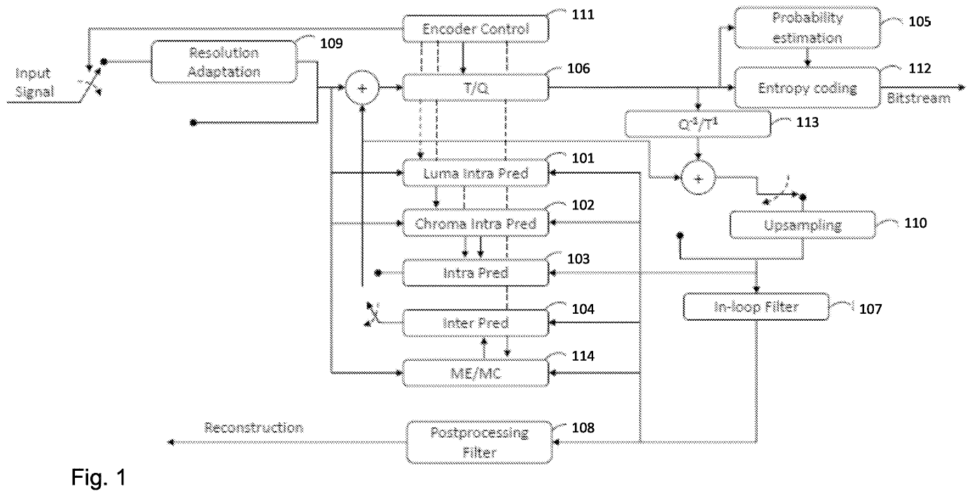

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:
A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.
A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.
An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.
A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.
A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.
An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.
A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.
A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.
An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.
An ME/MC block or circuit 114 performs motion estimation and/or motion compensation, which are two key operations to be performed when performing inter-frame prediction. ME/MC stands for motion estimation/motion compensation.

In another approach, commonly referred to as “end-to-end learned compression”, NNs are used as the main components of the image/video codecs. In this second approach, there are two main options:

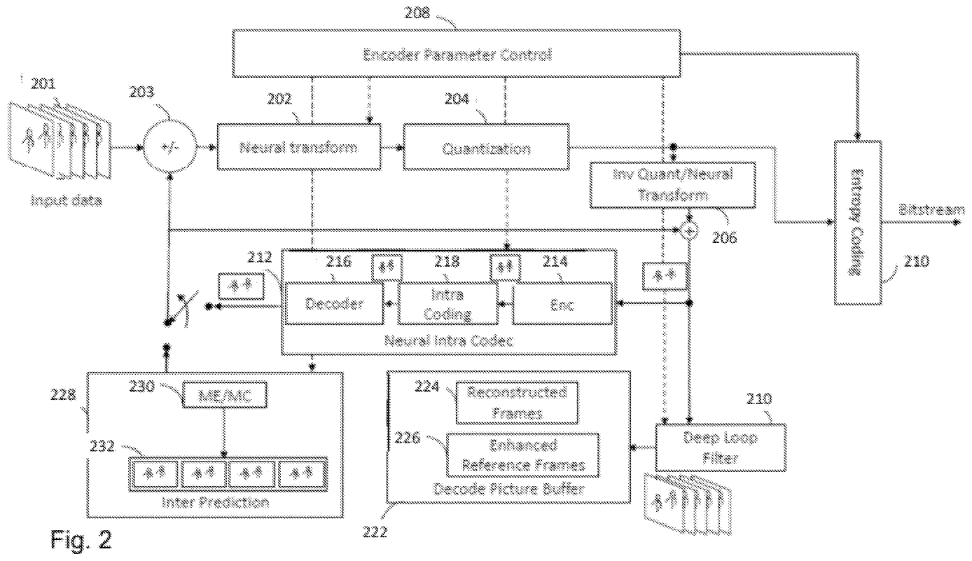

Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
A neural transform block or circuit 202: this block or circuit transforms the output of a summation/subtraction operation 203 to a new representation of that data, which may have lower entropy and thus be more compressible.
A quantization block or circuit 204: this block or circuit quantizes an input data 201 to a smaller set of possible values.
An inverse transform and inverse quantization blocks or circuits 206. These blocks or circuits perform the inverse or approximately inverse operation of the transform and the quantization, respectively.
An encoder parameter control block or circuit 208. This block or circuit may control and optimize some or all the parameters of the encoding process, such as parameters of one or more of the encoding blocks or circuits.
An entropy coding block or circuit 210. This block or circuit may perform lossless coding, for example based on entropy. One popular entropy coding technique is arithmetic coding.
A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
A deep loop filter block or circuit 220. This block or circuit performs filtering of reconstructed data, in order to enhance it.
A decode picture buffer block or circuit 222. This block or circuit is a memory buffer, keeping the decoded frame, for example, reconstructed frames 224 and enhanced reference frames 226 to be used for inter prediction.
An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.

Option 2: re-design the whole pipeline, as follows.
Encoder NN is configured to perform a non-linear transform;
Quantization and lossless encoding of the encoder NN's output;
Lossless decoding and dequantization;
Decoder NN is configured to perform a non-linear inverse transform.

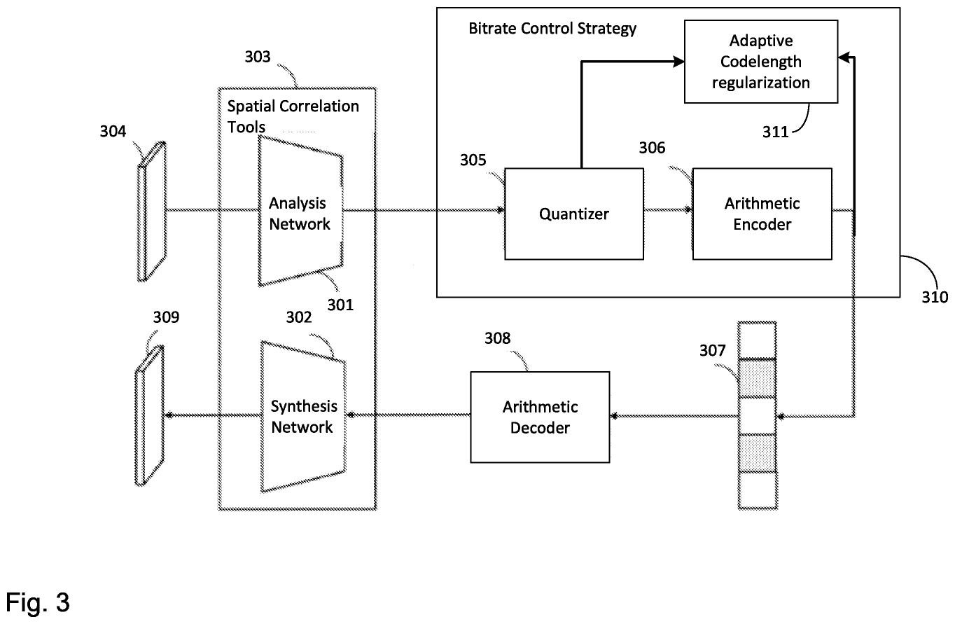

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error (f1, f2), where f1 and f2 are the features extracted by a pretrained neural network for the input data and the decoded data, respectively, and error( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. By “compressing”, we mean reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

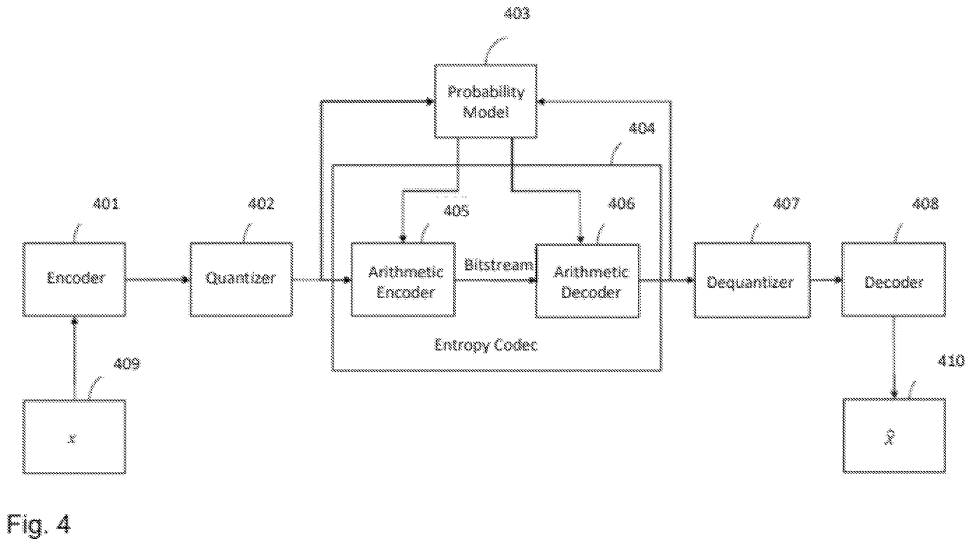

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

$$L = D + λ R ,$$

where D is the distortion loss term, R is the rate loss term, and λ is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

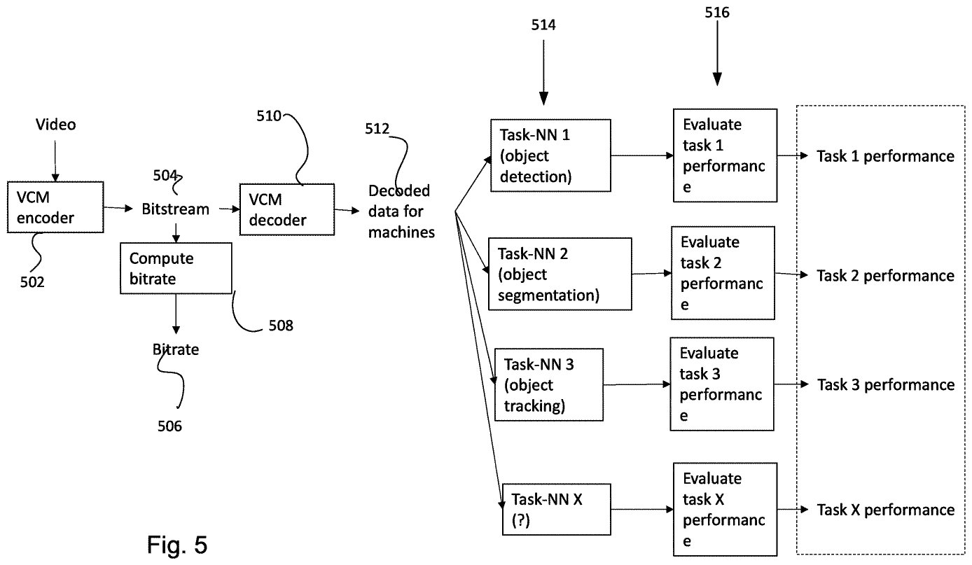

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human when rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate representation of the input video while guaranteeing that the task-NNs still perform well in terms of the evaluation metric 516 associated to each task.

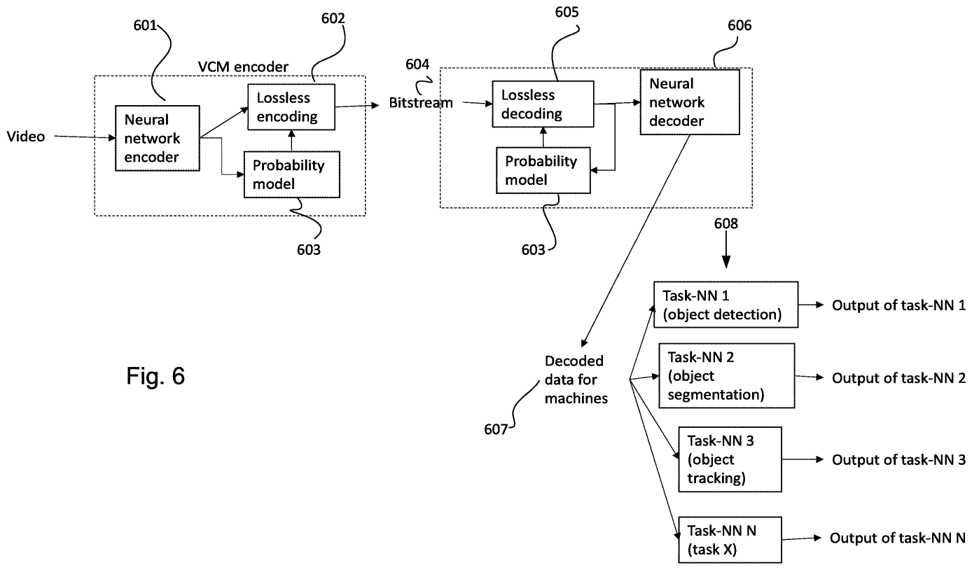

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The output of the neural network encoder 601 may be input also to a probability model 603 which provides to the lossless encoder 602 with an estimate of the probability of the next symbol to be encoded by the lossless encoder 602. The probability model 603 may be learned by means of machine learning techniques, for example it may be a neural network. At decoder-side, the bitstream 604 is input to a lossless decoder 605, such as an arithmetic decoder, whose output is input to a neural network decoder 606. The output of the lossless decoder 605 may be input to a probability model 603, which provides the lossless decoder 605 with an estimate of the probability of the next symbol to be decoded by the lossless decoder 605. The output of the neural network decoder 606 is the decoded data for machines 607, that may be input to one or more task-NNs 608.

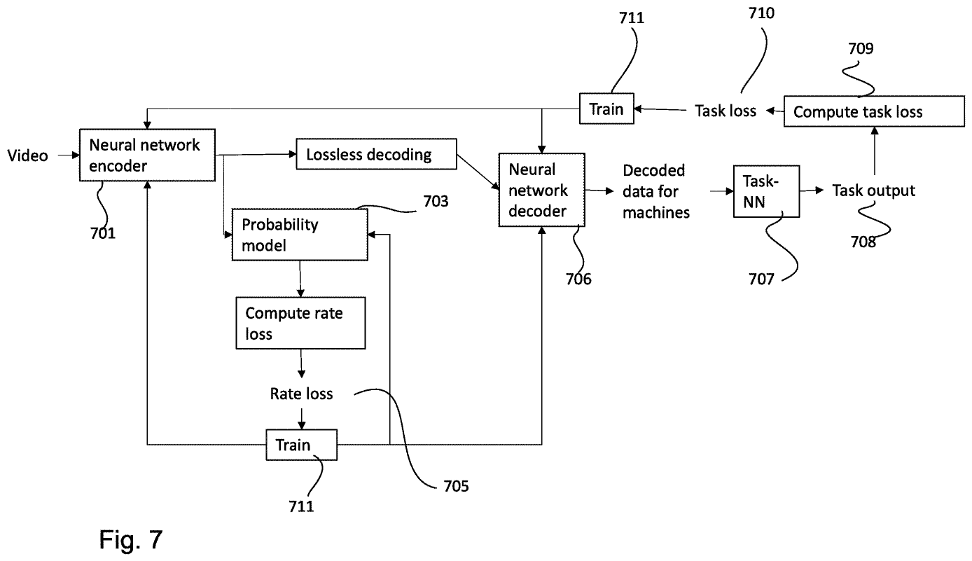

FIG. 7 illustrates an example of how the end-to-end learned system may be trained for the purpose of video coding for machines. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the trainable neural networks' parameters that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

A probability model may be used in an end-to-end learned codec to estimate probability distribution of the elements in the latent tensor, which is the output of the neural network encoder. The estimated probability distribution may be used by an arithmetic encoder to encode the latent tensor into a bitstream at the encoding stage, or by an arithmetic decoder to decode the latent tensor from the bitstream at the decoding stage. For lossless image and video compression, the probability model estimates the probability distribution of the elements in the input image or video for the arithmetic encoder and decoder to encode and decode the input image or video. In this disclosure, the term latent tensor may also refer to the input image or video in a lossless image or video compression system. In this disclosure, the term latent tensor and latent representation are used interchangeably. In this disclosure, a pixel in the latent tensor represents the vector located at a spatial location. The dimension of a pixel is the number of channels of the latent representation.

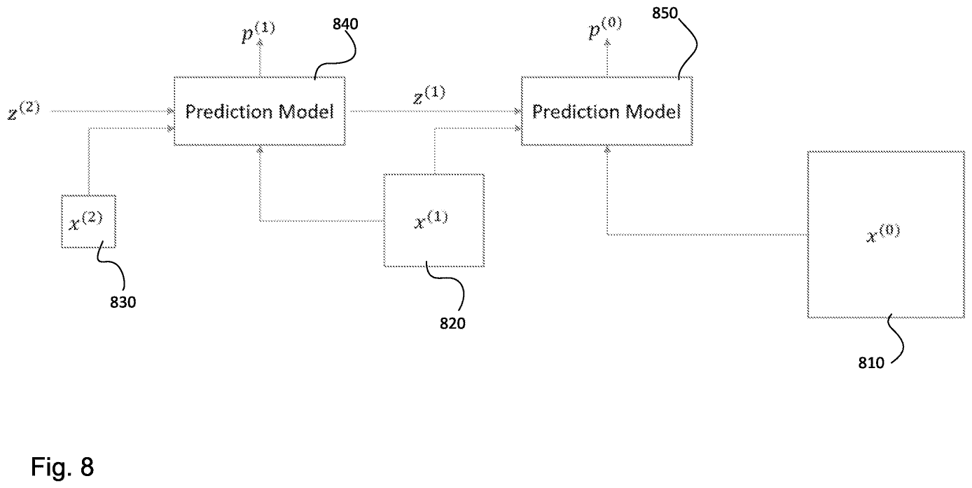

A multi-scale progressive (MSP) probability model may partition the elements in a latent tensor into multiple groups. The elements in one group may be processed in parallel and the groups may be processed sequentially. FIG. 8 shows an architecture of a multi-scale progressive probability model at the encoding stage according to one example. In the example of FIG. 8, the multi-scale progressive probability model comprises two prediction models 840, 850. Input latent tensor x⁽⁰⁾ 810 is first downsampled into a certain number of low-resolution representations 820, 830, e.g., x⁽¹⁾, x⁽²⁾. The downsampling operation may use the nearest neighborhood, bilinear, bicubic algorithm, or a learned neural network. If the downsampling algorithm is not the nearest neighborhood method, extra information may be transferred from the encoder to the decoder to recover the round-off error due to the downsampling operation. The probability distribution of the elements in the representation at the lowest resolution 830, i.e., x⁽²⁾ in FIG. 8, may be modelled as identically and independently distributed with a Gaussian distribution model, a uniform distribution model, or a mixture of probability distribution models. The probability of elements in the latent tensors in resolution levels other than the lowest one may be modelled by a conditional distribution model (whose parameters are estimated by a prediction model), where the conditioning information (also referred to as context) may comprise the representation at lower resolution levels. In FIG. 8, z⁽ⁱ⁾ is an auxiliary output from the prediction model 840 at resolution level i where i=1, 2, that may be used by the prediction model 850 at the next resolution level (i−1) as an extra input. p⁽ⁱ⁾ is the estimated parameters of the (conditional) probability distribution model for elements at resolution level i.

At the decoding stage, the latent tensor at the lowest resolution level, i.e., x⁽²⁾ in the FIG. 8, may be first decoded from the bitstream using the predefined probability distribution model. A multi-scale progressive probability model may use the elements in the latent tensor at resolution level i, e.g., x⁽ⁱ⁾, as the context to estimate the parameters of the distribution model for the elements in the latent tensor at a higher resolution level, e.g., x⁽ⁱ⁻¹⁾. The estimated probability distribution may be used by the arithmetic decoder to decode the elements in the bitstream. The procedure may repeat until all elements in the latent tensor at the highest resolution level, i.e., x⁽⁰⁾, is decoded.

The prediction models at different resolution levels may share the weights or a subset of the weights. In one example, the prediction models at different resolutions are the same or substantially the same.

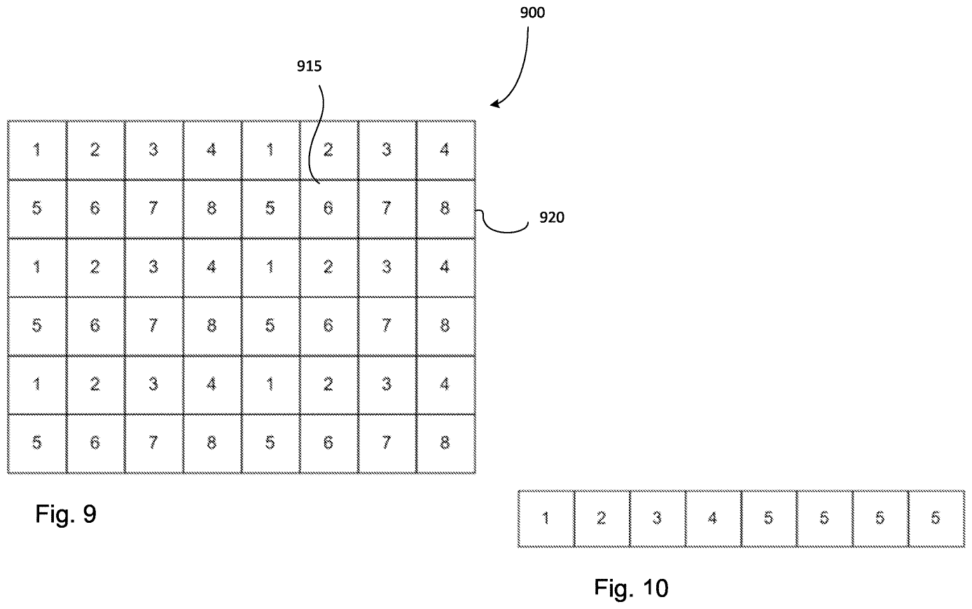

To further improve the accuracy of the probability distribution estimation, the elements in the latent tensor at each resolution level may be further partitioned into several groups, thus resulting in a several groups at each resolution level. The groups may be processed sequentially. The elements in a group are modelled by independent conditional distribution models using the elements that have already been processed as the context. That is, the elements of the latent tensor at a resolution level are processed in steps, where the elements in a group associated with a step are processed in parallel. In the following, pixels are used as examples of elements. FIG. 9 shows an example, where the pixels in a latent representation 900 are partitioned into 8 groups (a square in the latent representation represents a pixel, and the number in the square represents the group that the pixel belongs to). The pixels in one group may be processed in a batch. Assuming that pixels in groups 6 (915) and 8 (920) have already been processed from lower resolution representations and the processing order of the groups are predefined as 1, 2, 3, 4, 5, 7, as shown in FIG. 10. When pixels in group 1 are processed, pixels in groups 6 and 8 are used as context information. Next, the system process pixels in group 2 using pixels in group 1, 6, and 8 as the context information. This procedure repeats until all groups are processed.

A pixel in the latent representation may be a vector containing more than one channel. The MSP probability model may process the channels in a predefined order. The channels that have already been processed may be used as context information to estimate the probability distribution function of other channels. FIG. 10 shows the processing order of the channels of a pixel, where a square represents a channel of a pixel and the number in the square represents the processing order. The channels with the same processing order may be processed in parallel.

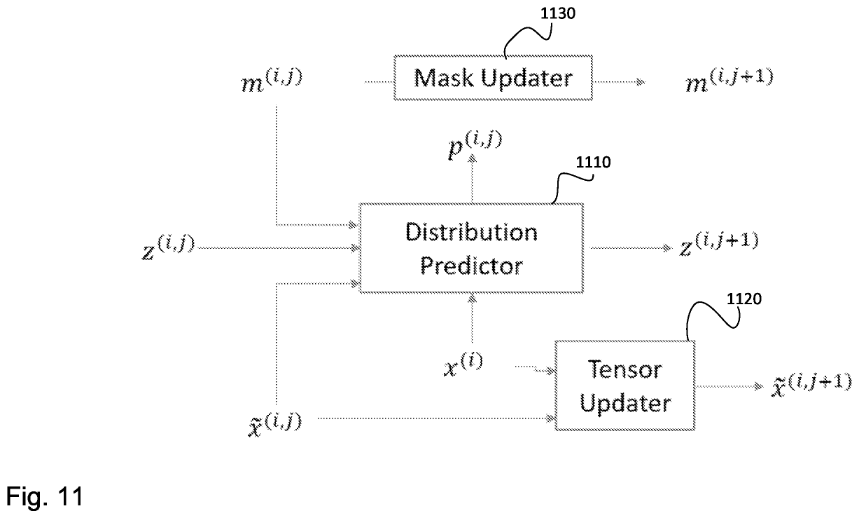

An architecture of the prediction model according to an example is shown in FIG. 11. Such prediction model can be part of the MSP probability model of FIG. 8.

Let N⁽ⁱ⁾ be the number of groups into which the elements in the latent representation at a resolution level i are partitioned. FIG. 11 shows the prediction model at the resolution level i and step j, where j=1, . . . , N⁽ⁱ⁾. The distribution predictor 1110 predicts parameters of the probability distribution for the elements in the latent representation at the resolution level i and step j. z^{(i,j)} is the auxiliary input for the distribution predictor 1110. For the first step, z^{(i,1)}=z⁽ⁱ⁺¹⁾, where z⁽ⁱ⁺¹⁾ is the auxiliary output from the resolution level i+1, i.e., z⁽ⁱ⁺¹⁾=z^{(i+1,N}^{⁽ⁱ⁺¹⁾}⁾. \tilde{x}^{(i,j)} is a tensor that contains the true values for the elements that have already been processed and the predicted values of the elements that have not been processed at step j. \tilde{x}^{(i,1)} is derived by upsampling x⁽ⁱ⁺¹⁾. m^{(i,j)} is a binary-valued mask tensor with the same shape of \tilde{x}^{(i,j)} indicating the positions of the elements in \tilde{x}^{(i,j)} that have true values. p^{(i,j)} is the estimated parameters of the probability distribution for the elements in group j at resolution level i. At the encoding stage, after p^{(i,j)} is calculated, the tensor updater component 1120 may update the elements in group j with the corresponding true values in x⁽ⁱ⁾ to generate \tilde{x}^{(i,j+1)}, and the mask updater component 1130 may update the mask tensor m^{(i,j)} accordingly to generate m^{(i,j+1)}. At the last step, i.e., j=N⁽ⁱ⁾, let z⁽ⁱ⁾=z^{(i,N}^{⁽ⁱ⁾}⁾.

At the decoding stage, the calculated p^{(i,j)} is used to decode the corresponding elements in the bitstream. After a group of elements is decoded, the corresponding values are updated in \tilde{x}^{(i,j)} to generate \tilde{x}^{(i,j+1)} and mask tensor m^{(i,j)} is updated accordingly to generate m^{(i,j+1)}. The prediction model repeats this operation in N⁽ⁱ⁾ steps until all elements at the resolution level i are processed.

For an application where image/video coding is applied, some regions of the input frame may contain important information for the system, while other regions are less important. The regions that are important for the system may be referred to as regions of interest (ROIs) or foreground regions. Regions other than the foreground regions may be referred to as non-ROIs or background regions. For instance, when the system performs an object detection task, ROIs may include objects that are supposedly detected by the object detection task network.

In conventional image/video codecs, a frame may be partitioned into processing blocks, for example, coding tree unit (CTU) and coding unit (CU). The rate-distortion trade-off of each processing block may be controlled by parameters, such as the quantization parameter (QP). For processing units that fall into the ROI or overlap significantly with the ROI, encoding parameters that achieve high reconstruction quality may be applied.

For end-to-end learned neural network-based image/video codec, an input frame is processed in a non-block manner. For example, the whole input frame is transformed by a neural network encoder to generate a latent representation to be quantized and encoded into a bitstream by the entropy encoder using the distribution estimated by the probability model. Since the input frame is processed as a whole, encoding foreground and background regions with different qualities is a difficult task.

Given the information of the ROIs as input, the encoder may encode the ROIs with higher qualities while encoding the non-ROIs with lower qualities. ROI-based encoding may refer to an encoding process, where only some region(s) of an image or a frame are encoded with a high-quality, while rest of the image or the frame is encoded with lower quality. The term “quality” in relation to ROI-based coding does not necessarily mean quality as perceived by human beings and may additionally or alternatively mean “quality” as analyzed by a machine task, wherein higher quality may, for example, imply a higher machine analysis precision and lower quality may, for example, imply a lower machine analysis precision.

At least some of the present embodiments relate to neural network-based image/video codec to support ROI-based encoding, i.e., encoding different regions in the input data with different qualities.

Unlike conventional video coding, where the input is processed in blocks, it is difficult for neural network-based learned image/video codecs to support ROI-based encoding. Two solutions to attack this challenge can be found from the technology. In a first solution, the codec is trained in an end-to-end manner by taking an ROI map, a binary map as an indication of foreground regions. In the second solution, an ROI map is processed by a neural network, (i.e., a gain codec), to generate a scale tensor that is applied to the latent representation to adjust the quantization level and adjust the quality and bitrate for different regions. Since the codec is end-to-end trained with a predefined weight parameter that determines the quality difference between the foreground regions and background regions, neither of these methods provides a flexible solution to adapt the qualities of foreground regions and background regions. Thus, to support the ROI coding, the performance of the codec is compromised.

Some of the present embodiments take advantage of multiscale progressive probability models in an end-to-end learned image/video codec. The present embodiments provide a flexible mechanism to adjust the quality of foreground and background regions without compromising the performance of the codec for normal encoding.

The present embodiments allow learned image codecs to support ROI-based encoding, i.e., encoding the input data such that different qualities may be achieved for the foreground regions and background regions of the reconstructed data.

Any ROI detection method may be used together with the present embodiments for encoding. There are alternatives to detect regions of interest in the image or the frame, which comprise, e.g., usage of task neural networks, feature-based algorithms, object-based algorithms, saliency-based algorithms, or their combination. For example, ROI detection may be performed using a task NN, such as an object detection NN or an instance segmentation NN. Additionally or alternatively, in another example, an object tracking method or an object tracking NN may be used to detect ROIs.

Some ROI detection methods may provide a rectangular bounding box that includes one or more ROIs. Other ROI detection methods may provide boundaries of a region that may be non-rectangular. Embodiments are not limited to rectangular ROIs unless specifically described.

ROI-based encoding for learned image codecs is achieved by a method for encoding comprising the following steps according to an embodiment. At first an input frame is received. The input frame represents a frame of a video or an image. The input frame is not partitioned into blocks. The input frame is transformed into a latent representation (also called as latent tensor), and the latent representation is quantized as shown with reference to FIG. 4. The latent representation has at least a foreground region and a background region, representing content at the foreground of the input frame and content of the background of the input frame, respectively. The different regions of the latent representation may be determined or identified by the encoder as discussed in a more detailed manner later. The latent representation may be downsampled into several low-level resolution representations, whereupon the following steps are performed for latent representation at each resolution level. A probability model, such as MSP probability model, estimates probability distribution of a selected set of elements (i.e., pixels) of the latent representation based on a context that is constructed from e.g., data that has already been encoded. The method and the parameters that are used for estimation can be determined by the encoder as will be discussed in more detailed manner below. A set of the elements that fall outside of the selected set of elements, is skipped by the probability model. For such set of elements, the encoder estimates the value to be used instead of the true values. The method and the parameters that are used for estimation can be determined by the encoder as will be discussed in a more detailed manner below. The skipped set of elements can represent pixels of the background region, but according to other embodiments the skipped set of elements can represent any selected region of the latent representation. The encoder encodes the elements into the bitstream so that the selected set of elements are encoded by using the probability distribution and the set of elements falling outside the selected set of elements are skipped. These encoded values and the estimated values of the skipped elements are used to generate context data for higher levels of resolution when estimating the probability distribution of the elements. The encoder may encode the location and the size information about the foreground or the background regions, or the indication information of the set of elements that are encoded or skipped into the bitstream.

In addition, there is a method for decoding comprising the following steps according to an embodiment. At first, a bitstream is received by the decoder. The decoder may decode the location and size information about the foreground or the background regions, or the indication information of the set of elements that are encoded or skipped from the bitstream. When the location and foreground or background regions are decoded from the bitstream, the decoder may derive the indication of the set of elements that has been encoded in the bitstream. Next, the decoder may decode the lowest-resolution representation of the latent representation from the bitstream using the predefined probability distribution model and the indication of the set of elements that are encoded into the bitstream. If an element in a low-level representation is skipped, the element is not decoded from the bitstream, and an estimated value is used for the skipped element. The decoder may continue to decode elements in a high-level resolution representation using the probability distribution estimated by the MSP probability model using the elements in lower-level representations that are either decoded from the bitstream or estimated as context information. The decoder may repeat this procedure until all elements in the highest-level of representation (i.e., the reconstructed latent representation) are recovered. Next, the reconstructed latent representation may be dequantized and processed by the neural network decoder to generate the reconstructed frame.

As discussed above, according to some of the embodiments, the pixels and/or elements of different regions in the latent representation are skipped at the encoding stage to reduce the size of the bitstream. The corresponding pixels and elements are also skipped at the decoding stage.

According to some of the embodiments, different scale factors may be applied to the different regions of the latent representation before the latent representation is processed by the probability model and the arithmetic encoder. At the decoding stage, the inverse of the scale factors may be applied after the latent representation is decoded from the bitstream.

According to some of the embodiments, the neural network decoder and/or post-filter may be trained or finetuned to tolerate the mixed quality of the latent representation.

These and other embodiments are discussed in more detailed manner in below.

For a neural network-based image/video codec, the latent representation may have a lower resolution than the input data. For example, the neural network encoder may downsample input data three times, generating a latent representation with the height and weight value as one-eight of the input data. At the decoder side, the neural network decoder may upsample the latent representation accordingly during the transform, generating the reconstructed data with the same resolution as the input data.

A region in the latent representation that corresponds to the foreground region of an input picture is referred to as the corresponding foreground region (CFR). The region corresponding to a background region of the input picture is referred to as the corresponding background region (CBR). The pixels (i.e., elements) in the CFR are referred to as corresponding foreground pixels (CFPs). The pixels (i.e., elements) in CBRs are referred to as corresponding background pixels (CBPs).

According to an embodiment, at the encoding stage, the CBPs in one or more scales (i.e., resolution levels) of the latent representation may be skipped by the MSP probability model, i.e., the CBPs are not encoded into the bitstream using the estimated probability distribution function. When a pixel or element is skipped by the entropy coding, an estimated value of that pixel or element is used instead of the true value for future processing. For example, if a pixel at scale (i.e., resolution level) is skipped, an estimated value of that pixel may be used as context information to estimate the probability distribution of elements in a higher resolution. According to another example, the estimated values for the skipped pixels, together with the non-skipped pixels, are used by the neural network decoder to generate the reconstructed data.

The estimated values for the skipped pixels may be derived by
a nearest neighbor algorithm, for example, taking the value of the nearest pixel or element that has already been processed;
a linear interpolation algorithm using pixels or elements that have already been processed;
a predictor neural network that is trained to predict the values of skipped pixels or elements using the pixels or elements that have already been processed. The predictor neural network may be trained using training data collected from the latent representations generated by the neural network encoder from an image/video dataset.

It is appreciated that the above is a list of examples, but the ways of deriving the estimated values are not limited to those examples. Also, when any other element than a pixel is used, the estimated values for such elements can be derived similarly.

At the decoding stage, the skipped pixels or elements may be predicted from the pixels or elements that have already been processed using the same estimation method as the one used at the encoding stage. Non-skipped pixels or elements are decoded from the bitstream using the probability distribution functions estimated by the probability model.

According to some embodiments, the encoder may determine the estimation method, and/or the parameters of the estimation method, and signal the determined method and/or the parameters for the selected method to the decoder within or along the bitstream. In one example, the encoder may determine an estimation method and/or a set of parameters of the estimation method for all skipped elements in the latent representation and signal the determined estimation method and/or the set of parameters of the estimated method to the decoder. In one example, the encoder may determine an estimation method and/or a set of the parameters of the estimation method for the latent representation at each scale (i.e., resolution level) and signal the determined estimation method and/or the set of parameters of the estimation method for each scale (i.e., resolution level) to the decoder. In another example, the encoder may determine an estimation method and/or a set of parameters for the estimation method for each set of the elements that the probability model processes in a batch and signal the determined estimation method and/or the set of parameters of the estimation method for each batch to the decoder.

In some of the embodiments, the encoder may determine the estimation method by comparing the Rate-distortion (RD) losses of the codec using a set of estimation methods and select the estimation method that achieve the lowest RD loss. In another example, the encoder may determine the set of the parameters of the estimation method by minimizing the RD loss of the codec. In another example, a neural network may be trained to predict the optimal estimation method using a training dataset and the trained neural network may be used at the inference stage to estimate the estimation method for the skipped pixels.

In some of the embodiments, the encoder may determine the locations of the CFRs, and signal the determined locations to the decoder within or along the bitstream. The location of a CFR may, for example, be represented by any of the following:
The coordinates of the top-left and bottom-right corners of the CFR.
The coordinate of the center of CFR, the width, and height of the CFR.
The coordinate of the top-left corner of the CFR relative to the top-left corner of the picture, the width, and the height of the CFR.
For the case, where CFRs are indicated in raster scan order of their top-left corner, the width, and the height of the CFR, and
   for the first CFR of the picture, the coordinate of the top-left corner of the CFR relative to the top-left corner of the picture;
   for other CFRs of the picture, the coordinate of the top-left corner of the CFR relative to the top-left corner of the previous CFR.
The index of the item from a predefined set of bounding box templates (a.k.a. anchors). Optionally there may be offset values and/or scale factors to express the deviations from the selected anchor.

In some other embodiments, one or more CFRs may be represented by a binary mask, referred to as CFR indication mask. The CFR indication mask may have the same resolution as the latent representation and the elements are either 0 or 1, where 1 indicates the pixel is a CFP.

In another embodiment, the latent representation may be partitioned into blocks. The encoder may determine whether the pixels in a block are CFPs or CBPs from the given foreground and background regions. Next the encoder may generate an indication mask at the block level, referred to as CFR block indication mask, where each element in the mask is associated with a block and the value of the element indicates whether the pixels in the block are CFPs or CBPs. The indication mask may be signaled to the decoder within or along the bitstream. The block size may be predetermined, for example, in a coding standard, or an encoder may indicate the block size in or along the bitstream, and a decoder may decode the block from or along the bitstream.

According to some of the embodiments, the CFR indication mask and/or CFR block indication mask may be compressed before being included in or along the bitstream or signalling to the decoder. For example, run-length encoding may be applied. In another example, context-based arithmetic coding may be applied, wherein the classification of the top and left neighbours to be within CFR may be used as the context.

According to an embodiment, a CFR indication mask contains non-binary values indicative of the number of skipped elements and/or the scale (i.e., resolution level) of the latent tensor at which elements are skipped.

According to an embodiment, non-binary values of a CFR indication mask are determined based on a confidence level of a detected ROI. Values in a CFR indication mask are selected so a higher confidence of the respective detected ROI results in a higher fidelity of the region reconstructed from the CFR.

In another embodiment, the encoder may determine the mode with which the CFRs are encoded, for example, the coordinates mode, the CFR indication mask mode, and the CFR block indication mask mode. The CFR encoding model and the encoded CFR information may be signaled to the decoder within or along with the bitstream.

In another embodiment, the encoder may determine whether to encode the CFRs or the CBRs into the bitstream by computing the bitstream size required to encode them. The indication of the choice may be signaled to the decoder within the bitstream or along with the bitstream. The methods to encode CFRs may be applied to encode CBRs.

The decoder may decode the locations, the CFR indication mask, or the CFR block indication mask from the bitstream or messages along with the bitstream. The decoded CFRs or CBRs may be used by the probability model at the decoder side to decode the latent representation from the bitstream.

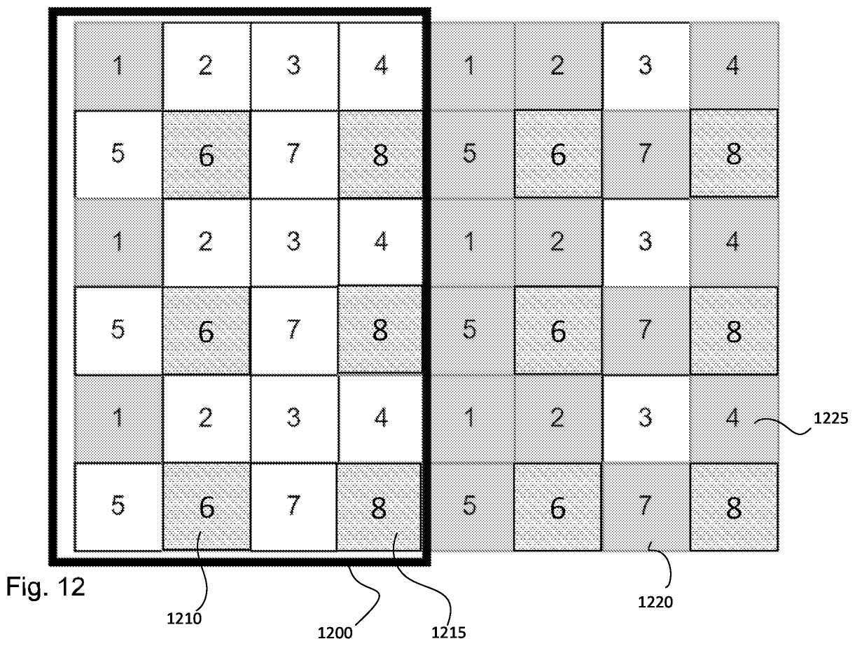

As has already been mentioned, an MSP probability model may partition the pixels in the latent representation into groups and process the groups in a predefined order. In some of the embodiments, patterns for the skipped pixels may be defined for the CFPs and CBPs. FIG. 12 illustrates an example of patterns defined for CFPs and CBPs. In FIG. 12, the pixels in the bolded area 1200 are CFPs, and the pixels outside the bolded area are CBPs. Pixels in groups 6 1210 and 8 1215 are the pixels that have been processed from lower-resolution representations. The pixels in squares (e.g., squares 1220, 1225) with gray color are the skipped pixels, i.e., the pixels are not encoded to the bitstream or decoded from the bitstream. For CFPs, a pattern is defined that pixels in group 1 are skipped pixels. For CBPs, pixels in groups 1, 2, 4, 5, and 7 are skipped pixels.

In one embodiment, the patterns for the CFPs and CBPs are determined at the encoding stage on the RD-loss of the codec on foreground regions and background regions. The determined pattern may be signaled to the decoder within or along the bitstream.

In another embodiment, the pattern may be predefined by the codec.

The decoder may decode the patterns from the bitstream or the corresponding messages along with the bitstream and apply the decoded patterns when decoding the latent representation from the bitstream.

As described earlier, the channels of a pixel may be processed in multiple steps and the channels that have already been processed may be used as context information to estimate the probability distribution function of other channels.

In some of the embodiments, the encoder may skip some channels of the CBPs at the encoding stage. In one example, the skipped channels may be predefined in the codec. In another example, the identifications (IDs) of the skipped channels may be signaled to the decoder within or along the bitstream. The decoder may decode the skipped channel IDs from the bitstream or the corresponding messages along with the bitstream and use decoded channel IDs when decoding the latent representation from the bitstream.

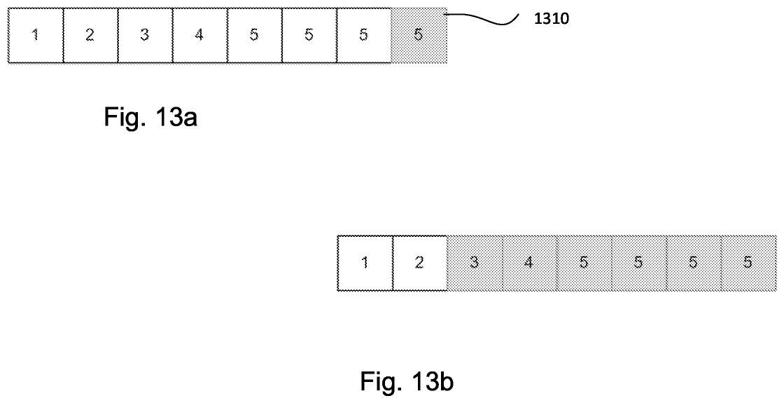

In another embodiment, the encoder may use predefined patterns for channels to encode the CFPs and CBPs. FIG. 13a shows a pattern for CFPs and FIG. 13b shows a pattern for CBPs. The channels 1310 in gray color are skipped at the encoding and decoding stage. In FIG. 13a, the last channel in channel group 5 1310c is skipped for the CFPs. In FIG. 13b, the channels in groups 3, 4, and 5 are skipped.

In one embodiment, the skipped channel patterns are predefined in the codec. In another embodiment, the skipped channel patterns are determined by the encoder based on the RD-target of the foreground regions and background regions.

In some embodiments, at the encoder side, a scale factor (which may interchangeably be referred to as a scaling factor) may be applied to the CBP of the latent representation before the quantization operation. In one example, a scale factor that is larger than one may be applied to CBPs. At the decoder side, the inverse of the scale factor may be applied to the corresponding CBPs after the latent representation has been decoded from the bitstream.

In one embodiment the scale factor for the CBPs may be predefined in the codec. In another embodiment, the scale factor may be determined by the encoder based on the targeted RD-losses of the foreground regions and background regions.

In an embodiment, a set of applicable scaling factors is pre-defined, for example in a coding standard, and may be associated with an index. The pre-defined scaling factors may, for example, target at bitrate difference steps that are approximately equal and practical to be used, while keeping the number of indices reasonable, such as approximately 64, 128, or 256. Assignment of scaling factors to indices may, for example, be linear, exponential, or follow any other pre-defined function, or assignment of scaling factors to indices may be pre-defined in a lookup table that may not follow any function. Rather than signaling absolute scaling factor(s) in or along the bitstream, index(es) of scaling factor(s) can be signaled in or along the bitstream. The indexes may be represented with a limited number of bits, such as 6, 7, or 8, which may be fewer than what would be used for absolute scaling factor(s). Furthermore, it may be possible to signal differences of scaling factor indexes, for example compared to the previous scaling factor index in raster scan order, using a differential variable length codeword. In some embodiments, the encoder may apply a different scale factor to the different channels of the latent representation. For example, a scale factor larger than one may be applied to one or more channels of the CBPs.

In an embodiment, the range of applicable scaling factors may be pre-defined, e.g., in a coding standard. In example, a scaling factor may range from 1.0 to a pre-defined maximum value. In another example, a scaling factor may range from a pre-defined minimum value, which may be, for example, in the range of 0 (exclusive) to 1 (exclusive), to a pre-defined maximum value. In an embodiment, an encoder may select a scaling factor less than 1.0, which may be used, e.g., for bitrate control.

In one embodiment, the encoder may use different scale factor values on different regions and/or different channels of the latent representation. The values of the scale factors may be determined based on
the size of the region;
the texture feature of the region, the texture feature may be determined by the statistical information of pixels and/or edges of the region;
the semantic information of the region, for example, a region containing human faces may be quantized differently than a region for buildings;
the confidence score of the objectiveness, the average confidence of one or more classes, or the maximum confidence score of one or more classes for the region achieved by a task neural network applied to the input data;
the saliency score for the region achieved by a saliency detection neural network applied to the input data.

The encoder may indicate the determined scale factor(s) in or along a bitstream. An encoder or another entity may signal the determined scale factor(s) to the decoder.

In some embodiments, the decoder may decode the scaling factors, the index of the predefined scaling factors, and/or the difference of the scaling factors from or along the bitstream and multiply the inverse scaling factor to an element when the value is decoded from the bitstream.

In an embodiment, an encoder determines, for example based on targeted RD-losses of the foreground regions and background regions, one or more scaling tensors and encodes the one or more scaling tensors in or along the bitstream, for example in a sequence-level syntax structure. A scaling tensor may comprise information indicative of one or more of the following associated with a block of latent representation:
Skipped corresponding pixels in the MSP probability model or the entropy codec;
Skipped channels;
Scale factor of non-skipped corresponding pixels, which may be indicated to be the same across all corresponding non-skipped pixels and channels, or may be given per corresponding non-skipped pixel and/or channel.

Encoding, according to an embodiment, comprises:
receiving an input frame;
transforming the input frame to generate a latent representation to be quantized;
determining from the latent representation a foreground region of the input frame and a background region of the input frame having corresponding foreground elements and corresponding background elements;
determining a scaling tensor for the background region, the scaling tensor comprising one or more of:
   skipped corresponding elements;
   skipped channels of the latent representation;
   scale factor of non-skipped corresponding background elements;
indicating the scaling tensor in or along a bitstream;
encoding information indicative of the background region in or along the bitstream;
encoding the latent representation into the bitstream using the scaling tensor.

The encoding, according to an embodiment, further comprises, in response to determining the scaling tensor to comprise skipped corresponding elements:
downsampling the latent representation into low-level resolution representations;
estimating parameters of a probability distribution of a selected set of elements of the latent representation and estimating values for rest of the elements at each resolution level; and
encoding the latent representation into a bitstream using the estimated parameters of the probability distribution for the selected set of elements and using estimated values for the rest of the elements.

Decoding, according to an embodiment, comprises:
receiving an encoded bitstream;
decoding a scaling tensor from or along a bitstream, the scaling tensor comprising one or more of:
   skipped corresponding elements;
   skipped channels of the latent representation;
   scale factor of non-skipped corresponding elements;
decoding information indicative of a region where a scaling tensor is applied;
decoding information on elements being encoded in the received bitstream, using the scaling tensor.

The decoding according to an embodiment further comprises, in response to the scaling tensor comprising skipped corresponding elements:
decoding lowest-resolution representation of a latent representation using a probability distribution model for elements that are encoded, wherein an estimated value is used for elements that has not been encoded in the bitstream;
continuing decoding elements in higher-resolution representations by the probability distribution using elements of lower-resolution representation that have been decoded or estimated until all elements in the highest-resolution latent representation have been decoded; and generating a reconstructed frame based on the highest-resolution latent representation.

Scaling tensors may be associated with an index or identifier. For example, the order of specifying scaling tensors may implicitly define their indices according to a pre-defined numbering rule.

In an embodiment, an encoder signals a scaling tensor index or identifier for each CBR.

In some embodiments, the decoder may decode the scaling tensor, the scaling tensor index, or the identifier from the bitstream and apply the associated pixel skip information, channel skip information and/or scale factor when decoding elements from the latent representation from the bitstream.

In an embodiment, the latent representation may be partitioned into blocks. The encoder may select which one of the one or more scaling tensors applies for each block and encode the indexes or identifiers of the selected scaling tensors in or along the bitstream. The block size may be pre-determined, for example in a coding standard, or an encoder may indicate the block size in or along the bitstream and a decoder may decode the block from or along the bitstream.

In some embodiments, the list of scaling tensor indexes or identifiers representing the block-wise selection of scaling tensors may be compressed before signaling to the decoder. For example, context-based arithmetic coding may be applied, wherein the scaling tensor index or identifier of the top and left neighbours may be used as the context.

In an embodiment, the block-wise signaling of the scaling tensor index or identifier is performed only for CBRs.

In an embodiment, the block-wise signaling of the scaling tensor index or identifier is performed for an entire picture. One or more scaling tensor indices or identifiers may be pre-defined, for example in a coding standard. For example, a scaling tensor index or identifier equal to 0 may be pre-defined to indicate a scaling tensor without skipped corresponding pixels and with scale factor equal to 1 (no quantization) across all corresponding pixels and channels. In this embodiment, explicit signaling of CBRs might not be needed.

Given the context information of an element to be encoded by the arithmetic encoder, the probability model may use a Gaussian distribution function to model the distribution of the element, for example, generating an estimated mean and scale value of the Gaussian function.

In some of the embodiments, the probability model may adjust the quantization levels for the elements in the latent representation. For example, after the mean and scale value of the Gaussian distribution function for an element are calculated, the probability model may apply a scale factor to the element value, the estimated mean value, and the estimated scale value. Next, it uses the adjusted mean and scale value to encode the adjusted element value to the bitstream. At the decoder side, the inverse of the scale factor may be applied to the estimated mean and scale values to decode the adjusted element value from the bitstream. Next, the inverse scale factor may be applied to the adjusted element value to get the decoded element of the latent representation. In normal cases, a scale factor larger than one may be applied to CBPs.

### ROI-Enabled Decoder

Since the quantized latent representation may contain both high-quality and low-quality elements, the reconstructed ROI regions may suffer from the low-quality background regions. For example, the low-quality elements in CBR may affect the pixels in foreground regions because of the large receptive field of the neural network decoder.

In one embodiment, the neural network decoder may be trained or finetuned to tolerate the mixed-quality latent representation. The training data may contain latent representations where ROI manipulations are applied, for example, by one or more of the aforementioned embodiments. The ground truth data may be the uncompressed input data. The neural network decoder may be trained or finetuned by minimizing the average mean square error (MSE), mean absolute error (MAE), or proxy loss of the reconstructed data.

In another embodiment, a recovery filter may be trained to improve the quality of the background regions. The recovery filter may be before or after the decoder neural network. When the recovery filter is before the decoder, the output of the recovery filter is the enhanced latent representation. When the recovery filter is after the decoder, the output of the recovery filter is the enhanced version of the reconstructed data.

The decoder neural network and/or the recovery filter may get as additional inputs, one or more of the following:
The ROIs information (e.g., position and size), the ROI information may be represented as the coordinates of bounding boxes, or a binary mask
The pattern of the skipped pixels, or channels
The scale factors for different CBRs and CFRs

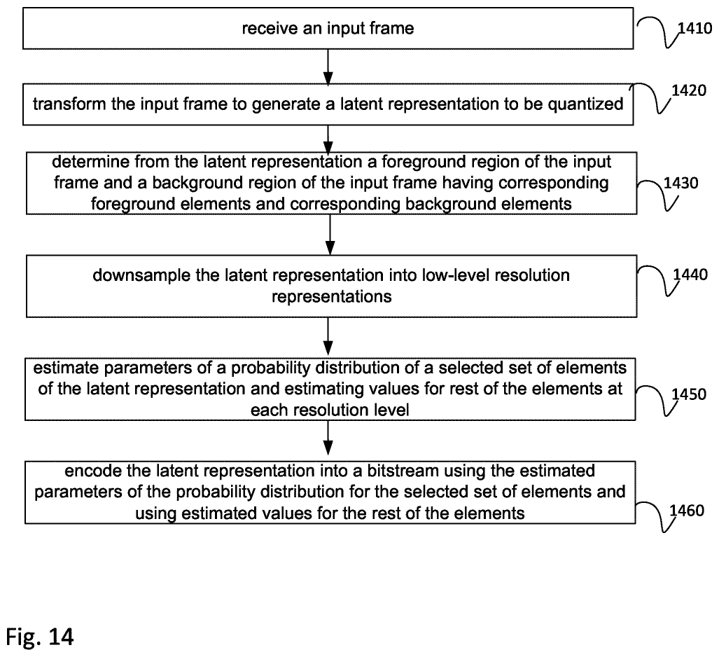

The method for encoding according to an embodiment is shown in FIG. 14. The method generally comprises receiving 1410 an input frame; transforming 1420 the input frame to generate a latent representation to be quantized; determining 1430 from the latent representation a foreground region of the input frame and a background region of the input frame having corresponding foreground elements and corresponding background elements; downsampling 1440 the latent representation into low-level resolution representations; estimating 1450 parameters of a probability distribution of a selected set of elements of the latent representation and estimating values for rest of the elements at each resolution level; and encoding 1460 the latent representation into a bitstream using the estimated parameters of the probability distribution for the selected set of elements and using estimated values for the rest of the elements. Each of the steps can be implemented by a respective module of a computer system.

An apparatus according to an embodiment comprises means for receiving an input frame; means for transforming the input frame to generate a latent representation to be quantized; means for determining from the latent representation a foreground region of the input frame and a background region of the input frame having corresponding foreground elements and corresponding background elements; means for downsampling the latent representation into low-level resolution representations; means for estimating parameters of a probability distribution of a selected set of elements of the latent representation and estimating values for rest of the elements at each resolution level; and means for encoding the latent representation into a bitstream using the estimated parameters of the probability distribution for the selected set of elements and using estimated values for the rest of the elements. The means comprises at least one processor, and a memory including a computer program code, wherein the processor may further comprise processor circuitry. The memory and the computer program code are configured to, with the at least one processor, cause the apparatus to perform the method of FIG. 14 according to various embodiments.

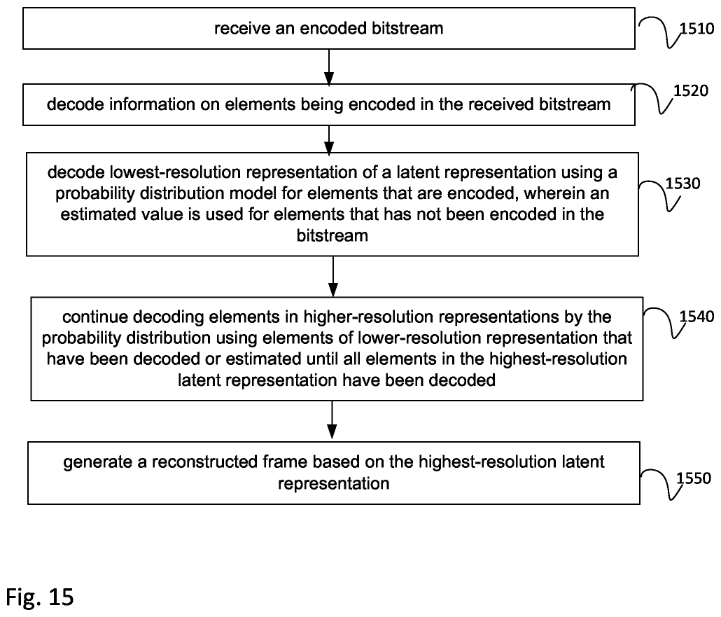

The method for decoding according to an embodiment is shown in FIG. 15. The method generally comprises receiving 1510 an encoded bitstream; decoding 1520 information on elements being encoded in the received bitstream; decoding 1530 lowest-resolution representation of a latent representation using a probability distribution model for elements that are encoded, wherein an estimated value is used for elements that has not been encoded in the bitstream; continuing 1540 decoding elements in higher-resolution representations by the probability distribution using elements of lower-resolution representation that have been decoded or estimated until all elements in the highest-resolution latent representation have been decoded; and generating 1550 a reconstructed frame based on the highest-resolution latent representation. Each of the steps can be implemented by a respective module of a computer system.

An apparatus according to an embodiment comprises means for receiving an encoded bitstream; means for decoding information on elements being encoded in the received bitstream; means for decoding lowest-resolution representation of a latent representation using a probability distribution model for elements that are encoded, wherein an estimated value is used for elements that has not been encoded in the bitstream; means for continuing decoding elements in higher-resolution representations by the probability distribution using elements of lower-resolution representation that have been decoded or estimated until all elements in the highest-resolution latent representation have been decoded; and means for generating a reconstructed frame based on the highest-resolution latent representation. The means comprises at least one processor, and a memory including a computer program code, wherein the processor may further comprise processor circuitry. The memory and the computer program code are configured to, with the at least one processor, cause the apparatus to perform the method of FIG. 15 according to various embodiments.

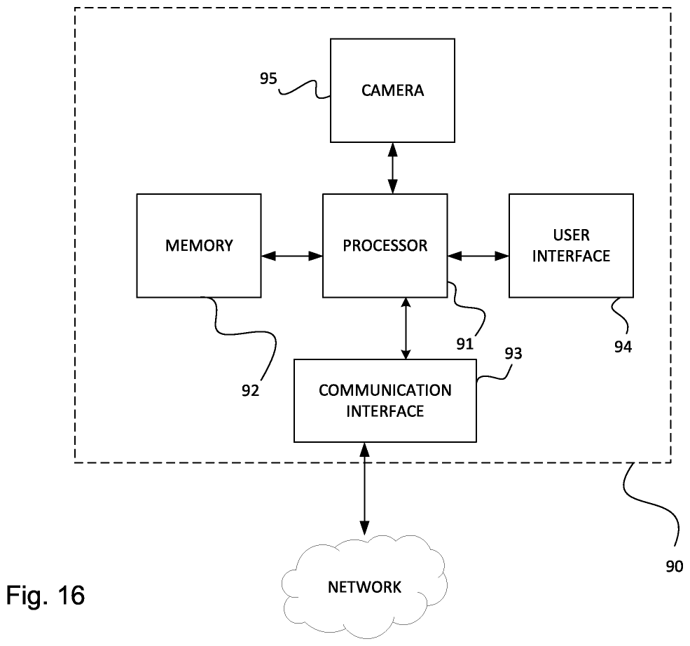

An example of an apparatus is shown in FIG. 16. The apparatus is a user equipment for the purposes of the present embodiments. The apparatus 90 comprises a main processing unit 91, a memory 92, a user interface 94, a communication interface 93. The apparatus according to an embodiment, shown in FIG. 16, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

Some embodiments have been described in relation to indicating locations of CFRs in or along the bitstream. It is to be understood that embodiments may be similarly realized by indicating locations of CBRs in or along the bitstream.

Some embodiments have been described in relation to decoding locations of CFRs from or along the bitstream. It is to be understood that embodiments may be similarly realized by decoding locations of CBRs from or along the bitstream.

Some embodiments have been described in relation to decoding information on location and size of a foreground region and information on location and size of background region. It is to be understood that decoding need not assign labels “foreground” or “background” to regions. and embodiments can be realized similarly to decoding a region with one or more of the following taken into account:
skipped corresponding elements;
skipped channels of the latent representation;
scale factor of non-skipped corresponding elements.

Some embodiments have been described in relation to encoding a foreground region of the input frame and a background region of the input frame. It is to be understood that embodiments can be realized similarly when regions are classified to more than two categories.

Some embodiments have been described in relation to indicating a scaling factor used in encoding, in or along a bitstream, directly or indirectly, e.g., through an index among a pre-defined set of scaling factors. It is to be understood that embodiments can be realized similarly by indicating an inverse scaling factor to be used in decoding, from or along a bitstream, directly or indirectly, e.g., through an index among a pre-defined set of inverse scaling factors.

Some example embodiments have been described in relation to a bitstream or the syntax of a bitstream. It needs to be understood, however, that the corresponding structure and/or computer program may reside at the encoder for generating the bitstream and/or at the decoder for decoding the bitstream.

Where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1. An apparatus for encoding, comprising:
means for receiving an input frame;
means for transforming the input frame to generate a latent representation to be quantized;
means for determining from the latent representation a foreground region of the input frame and a background region of the input frame having corresponding foreground elements and corresponding background elements;
means for downsampling the latent representation into low-level resolution representations;
means for estimating parameters of a probability distribution of a selected set of elements of the latent representation and estimating values for rest of the elements at each resolution level; and
means for encoding the latent representation into a bitstream using the estimated parameters of the probability distribution for the selected set of elements and using estimated values for the rest of the elements.

2. The apparatus according to claim 1, further comprising means for determining a method for estimating the values for the rest of the elements and encoding an indication of the method for estimating into a bitstream.

3. The apparatus according to claim 1, further comprising determining an estimation method for the latent representation at each resolution level.

4. The apparatus according to claim 1, further comprising means for determining a method for estimating the selected set of elements.

5. The apparatus according to any of the claims 2 to 4, further comprising means for determining a set of parameters for the determined estimation method and means for encoding the set of parameters into the bitstream.

6. The apparatus according to any of the claims 1 to 5, further comprising means for using a binary mask representing foreground regions to identify a foreground region in the latent representation

7. The apparatus according to any of the claims 1 to 5, further comprising means for partitioning the latent representation into blocks and means for determining whether elements in a block are foreground elements or background elements, and means for generating an indication mask indicating the foreground elements and the background elements and encoding the indication mask into a bitstream

8. The apparatus according to any of the claims 1 to 7, wherein the values for rest of the elements are estimated by using one of the following: a nearest neighbor algorithm; a linear interpolation algorithm using elements having already been processed; a predictor neural network being trained to predict the values of for rest of the elements using the elements that have already been processed.

9. The apparatus according to any of the claims 1 to 8, wherein the selected set of elements comprises foreground elements, and the rest of the elements comprises background elements.

10. The apparatus according to any of the claims 1 to 9, further comprising applying different scale factors to different regions of the latent representation before the latent representation is processed for the probability distribution.

11. The apparatus according to any of the claims 1 to 10, further comprising means for encoding one or more scaling factors, and/or index of the predefined scaling factors and/or difference of the scaling factors into the bitstream.

12. An apparatus for decoding, comprising
means for receiving an encoded bitstream;
means for decoding information on elements being encoded in the received bitstream;
means for decoding lowest-resolution representation of a latent representation using a probability distribution model for elements that are encoded, wherein an estimated value is used for elements that have not been encoded in the bitstream;
means for continuing decoding elements in higher-resolution representations by the probability distribution using elements of lower-resolution representation that have been decoded or estimated until all elements in the highest-resolution latent representation have been decoded; and
means for generating a reconstructed frame based on the highest-resolution latent representation.

13. The apparatus according to claim 12, wherein the information on elements that are encoded in the received bitstream comprises one or more of the following: information on location and size of foreground region; information on location and size of background region; indication information of set of elements that are encoded; indication information of set of elements that are skipped.

14. The apparatus according to claim 12 or 13, further comprising means for dequantizing the highest-resolution latent representation before reconstructing the frame.

15. The apparatus according to claim 12 or 13 or 14, further comprising means for decoding one or more scaling factors, and/or index of the predefined scaling factors and/or difference of the scaling factors from the bitstream.

16. The apparatus according to claim 15, further comprising means for determining the scaling factor for an element in the latent representation based on the information on the element that is decoded from the bitstream and applying an inverse of the scaling factor to the element after it has been decoded from the bitstream.

17. The apparatus according to any of the claims 12 to 16, further comprising a recovery filter to improving quality of elements that have not been encoded in the bitstream.

18. A method for encoding, comprising:
receiving an input frame;
transforming the input frame to generate a latent representation to be quantized;
determining from the latent representation a foreground region of the input frame and a background region of the input frame having corresponding foreground elements and corresponding background elements;
downsampling the latent representation into low-level resolution representations;
estimating parameters of a probability distribution of a selected set of elements of the latent representation and estimating values for rest of the elements at each resolution level; and
encoding the latent representation into a bitstream using the estimated parameters of the probability distribution for the selected set of elements and using estimated values for the rest of the elements.

19. A method for decoding, comprising:
receiving an encoded bitstream;
decoding information on elements being encoded in the received bitstream;
decoding lowest-resolution representation of a latent representation using a probability distribution model for elements that are encoded, wherein an estimated value is used for elements that has not been encoded in the bitstream;
continuing decoding elements in higher-resolution representations by the probability distribution using elements of lower-resolution representation that have been decoded or estimated until all elements in the highest-resolution latent representation have been decoded; and
generating a reconstructed frame based on the highest-resolution latent representation.
